(19) United States
(12) Patent Application Publication
(10) Pub. No.: US 2005/0151921 A1
(43) Pub. Date: Jul. 14, 2005

(54) Liquid crystal display apparatus and fabrication method of the same

(75) Inventor: Mamoru Okamoto, Kanagawa (JP)

Correspondence Address: YOUNG & THOMPSON, 745 SOUTH 23RD STREET, 2ND FLOOR, ARLINGTON, VA, 22202, US

(73) Assignee: NEC LCD TECHNOLOGIES, LTD., KANAGAWA (JP)

(21) Appl. No.: 11/033,399

(22) Filed: Jan. 12, 2005

(30) Foreign Application Priority Data
Jan. 13, 2004 (JP) 2004-005921

(51) Int. Cl. G02F 1/1333

(52) U.S. Cl. 349/158

(57) ABSTRACT

In a liquid crystal panel, a color filter substrate and an array substrate are provided in parallel with each other, and a liquid crystal layer is sealed therebetween. In the color filter substrate, a black matrix made of a resin and color filters are provided on a transparent substrate. In the array substrate, a pixel circuit is provided on a transparent substrate. The pixel circuit includes a gate interconnection, a gate insulating film, a semiconductor region, a drain interconnection, a passivation film, a pixel electrode, and the like. The sum of the step heights on the surfaces of the color filter substrate and the array substrate both facing the liquid crystal layer is 0.83 μm, and the pre-tilt angle of the liquid crystal layer is set to 4 degrees or more.

### BACKGROUND OF THE INVENTION

1. Field of the Invention

The present invention relates to a liquid crystal display apparatus and a fabrication method of the same.

2. Description of the Related Art

A liquid crystal display apparatus has a light source and a liquid crystal panel. The liquid crystal panel has two transparent substrates and a liquid crystal layer filled between the transparent substrates. The light source illuminates the liquid crystal panel while a voltage is applied to the liquid crystal layer in the liquid crystal panel to control its light transmittance, thereby displaying an image. To perform this operation, a pixel circuit that applies a voltage to the liquid crystal layer is provided on one of the transparent substrates in the liquid crystal panel, and color filters are provided on the other transparent substrate. The pixel circuit has, for example, a plurality of thin film transistors (TFTS) arrayed in a matrix. In the following descriptions, the substrate having the pixel circuit is referred to as “array substrate,” and the substrate having the color filters is referred to as “color filter substrate.”

FIG. 1 is a cross-sectional view showing a conventional liquid crystal panel. As shown in FIG. 1, the conventional liquid crystal panel 101 is provided with a color filter substrate 102 and an array substrate 103, which are arranged in parallel with each other. A liquid crystal layer 104 is also sealed between the color filter substrate 102 and the array substrate 103.

In the color filter substrate 102, a glass substrate 105 is provided. On the surface of the glass substrate 105 facing to the array substrate 103, a black matrix 106 formed of chromium (Cr) is provided. Color filters 107a and 107b are also provided on both sides of the black matrix 106 on the surface of the color filter substrate 102. The edges of the color filters 107a and 107b are formed so as to mount on the edges of both sides of the black matrix 106. The color filters 107a and 107b are, for example, red (R) and green (G) filters, respectively.

In the array substrate 103, a glass substrate 108 is provided. On the surface of the glass substrate 108 facing to the color filter substrate 102, two gate interconnections 109 formed of chromium (Cr) are provided. On the surface of the color filter substrate 102, a gate insulating film 110 is also provided so as to cover the gate interconnections 109. A step is created in part of the gate insulating film 110 corresponding to the region directly above the gate interconnection 109 by an effect of the shape of the interconnection 109. A drain interconnection 111 formed of Cr is provided on part of the gate insulating film 110 directly above the region between the gate interconnections 109.

A passivation film (PA-film) 112 is provided so as to cover the drain interconnection 111, and also pixel electrodes 113 of an indium tin oxide film (ITO-film) are provided on the passivation film 112. The pixel electrodes 113 are provided in a region except directly above the region between the gate interconnections 109, and the edges of the pixel electrodes 113 overlap with the edges of the gate interconnections 109 when viewed from a direction perpendicular to the surface of the glass substrate 108 (referred to below as ‘in plan view’). A step is created in the region including the edges of the pixel electrodes 113 and the exposed area of the passivation film 112 by an effect of the shapes of the gate interconnections 109 and the drain interconnection 111.

Thus, on the surface of the array substrate 103, a thin film transistor (TFT) is formed. The TFT has the gate interconnection 109, the drain interconnection 111, a source interconnection (not shown), and a semiconductor layer (not shown). The semiconductor layer is formed of amorphous silicon (a-Si). And a plurality of the TFTs are arrayed in a matrix to form a pixel circuit. In plan view, the drain interconnection 111 is disposed at a position overlapping with part of the region of the black matrix 106 not covered by the color filters 107a and 107b. Each pixel of the liquid crystal panel 101 has a single color filter provided in the color filter substrate 102 and a single TFT provided in the array substrate 103.

Exemplary dimensions of each part of the liquid crystal panel 101 are as follows. In the cross-section shown in FIG. 1, the width of the black matrix 106 is 20.0 μm, and the part of the black matrix 106 not covered with the color filters 107a and 107b, i.e., the region directly contacting with the liquid crystal layer 104, is about 7.0 μm wide. The width of each of the gate interconnections 109 is 5.5 μm, and the spacing therebetween is 8.0 μm. The width of the drain interconnection 111 is 5.0 μm, and the distances between the drain interconnection 111 and each of the gate interconnections 109 are 1.5 μm on both sides in plan view.

Further, in plan view, the overlap regions between the pixel electrodes 113 and the gate interconnections 109 are 3.0 μm wide for each region. The gate interconnections 109 and the drain interconnection 111 are each formed with a thickness of 140 nm, and the pixel electrodes 113 with a thickness of 40 nm. The distance from part of the surface of the black matrix 106 exposed to the liquid crystal layer 104 to part of the surface of the passivation film 112 exposed to the liquid crystal layer 104 is approximately 5.3 μm.

Next, a fabrication method of such a conventional liquid crystal panel will be described. FIG. 2 is a flowchart showing the fabrication method of the array substrate of the conventional liquid crystal panel; FIGS. 3A through 3D and FIGS. 4A through 4D are cross-sectional views showing the fabrication method in order of the process steps. The array substrate of the liquid crystal panel is conventionally fabricated by the 5PR method in which photolithography (PR) is performed five times.

First, in step S11 in FIG. 2, a Cr film having a thickness of 140 nm is formed on the glass substrate 108 as a gate interconnection layer. Next, as shown in step S12 and in FIG. 3A, the first photolithography (PR) is carried out and the gate interconnection layer is patterned to form the gate interconnections 109. Next, as shown in step S13 and in FIG. 3B, the gate insulating film 110 is formed on the glass substrate 108 so as to cover the gate interconnections 109, followed by formation of the semiconductor layer 114 of amorphous silicon (a-Si). Next, as shown in step S14 and in FIG. 3C, the second PR is carried out and the semiconductor layer 114 is patterned to form a semiconductor layer pattern (not shown) for the TFT. Next, as shown in step S15 and in FIG. 3D, a Cr film having a thickness of 140 nm is formed on the gate insulating film 110 and semiconductor layer as a source and drain interconnection layer 115.

Next, as shown in step S16 and in FIG. 4A, the third PR is carried out and the source and drain interconnection layer 115 is patterned to form the drain interconnection 111 and the source interconnection (not shown). Next, as shown in step S17 and in FIG. 4B, the passivation film 112 is formed on the gate insulating film 110 so as to cover the drain interconnection 111 and the source interconnection. Next, in step S18, the fourth PR is carried out to form contact holes (not shown) in the gate insulating film 110 and the passivation film 112. Next, as shown in step S19 and in FIG. 4C, the ITO film 116 is formed on the passivation film 112. Next, as shown in step S20 and in FIG. 4D, the fifth PR is carried out and the ITO film 116 is patterned to form the pixel electrodes 113. The array substrate 103 is thus formed.

On the other hand, as shown in FIG. 1, the black matrix 106 of a Cr film is formed on the glass substrate 105, and then the color filters 107a and 107b are formed so as to cover the edges of this black matrix 106. The color filter substrate 102 is thus formed. After that, the array substrate 103 and the color filter substrate 102 are combined in parallel with each other by using a seal (not shown). Then liquid crystal is sealed in the space enclosed by the color filter substrate 102, the array substrate 103, and the seal to form the liquid crystal layer 104. The liquid crystal panel 101 is thus fabricated.

Such a liquid crystal apparatus as described above, however, has the following problems. Since a pixel circuit and the like are provided on the surface of the array substrate facing the liquid crystal layer and color filters and the like are provided on the surface of the color filter substrate facing the liquid crystal layer, steps are inevitably created on both the surfaces. Because of this, orientation disorder of the liquid crystal layer occurs at the steps, thereby causing an abnormal display to occur. Specifically, the orientation of the liquid crystal molecules cannot be aligned normally along the steps and is also easily affected by the lateral electric field generated from the drain interconnection, so that the reverse tilt occurs. As a result, the discrination occurs at these portions, and bright lines appear in an image.

Especially recently, to reduce cost and environmental load of the liquid crystal panel, technologies to form a black matrix (light blocking layer) with a resin instead of metal have been developed. As a result, the thickness of the black matrix increased. For example, whereas the black matrix formed of metal can obtain a sufficient light blocking property with a thickness of, for example, 0.1 μm, the black matrix formed of a resin requires a thickness of, for example, 1.5 μm to obtain the same property. Accordingly, the height of the portions where the color filters mount on the black matrix becomes higher, so the height of the steps in the color filter substrate increases.

Conventionally, when the color filter substrate having such large steps is used, an overcoat layer has been provided so as to cover the color filters and black matrix to fill in the steps. However, since providing the overcoat layer leads to increase in cost of the liquid crystal panel, it is preferable for the cost not to employ the overcoat layer. Further, in order to reduce fabrication cost, technologies to reduce the PR process from five to four times have recently been developed. As a result, part of the semiconductor layer directly below the drain interconnection is left, so that the steps in the array substrate are much more increased in height.

As described above, to reduce fabrication cost and environmental load, if one tries to form the black matrix of a resin, to omit the overcoat layer, and to reduce the fabrication process of the array substrate to the 4PR process, the heights of the steps in the color filter substrate and the array substrate are inevitably increased, so that the orientation disorder of the liquid crystal layer is more likely to occur.

To prevent the orientation disorder of the liquid crystal layer, a technology is described in, for example, Japanese Patent Laid-Open Publication No. Hei 09-96806, in which a protection film of a resin is formed on the edges of electrodes, interconnections, and switching elements of a pixel circuit to form a black matrix having sloped side walls.

The technology described in Japanese Patent Laid-Open Publication No. Hei 09-96806, however, has the following problems. In this technology, since both pixel circuit and black matrix must be provided in the array substrate, steps created by the black matrix are added to those created by the pixel circuit in the array substrate, so the steps in the array substrate increase considerably in height. This adversely results in more occurrence of the orientation disorder. Further, a resin used to form the black matrix includes carbon, so that the conductivity thereof is high. Therefore, another problem with this technology is that, if the black matrix is formed so as to cover the pixel circuit, a leakage current is likely to occur, so the performance of the pixel circuit deteriorates.

### SUMMARY OF THE INVENTION

An object of the present invention is to provide a low cost liquid crystal display apparatus and a fabrication method thereof that can make orientation disorder of a liquid crystal layer hard to occur.

A liquid crystal display apparatus according to the present invention includes a first substrate, a second substrate provided in parallel with the first substrate, and a liquid crystal layer sealed between the first and second substrates. The first substrate includes a first transparent substrate, and a pixel circuit, which is provided on the surface of the first transparent substrate and applies a voltage to the liquid crystal layer. The second substrate includes a second transparent substrate, a black matrix made of a resin provided on the second transparent substrate, and a color filter which is provided on the second transparent substrate and colors transmitted light therethrough. And, a sum of heights of steps created on the surfaces of the first and second substrates both facing the liquid crystal layer is equal to, or greater than, 0.8 μm. A pre-tilt angle of the liquid crystal layer is equal to, or greater than, 4 degrees.

In the present invention, even if the sum of the step heights in the first and second substrates is equal to, or greater than, 0.8 μm, the occurrence of orientation disorder can be prevented in such a way that: the pixel circuit and the black matrix are separately formed in the different substrates so that the steps in the different substrates are independently created; and a pre-tilt angle of the liquid crystal layer is equal to, or greater than, 4 degrees. Also, The black matrix formed of a resin can reduce the cost of the liquid crystal display apparatus.

When the sum of the step heights is equal to, or greater than, 1.2 μm, it is preferable to set the pre-tilt angle of the liquid crystal layer to 5 degrees or more. The occurrence of the orientation disorder can thereby certainly be prevented. It is also preferable to set the pre-tile angle to 10 degrees or less, thereby obtaining a stable orientation of the liquid crystal layer.

A fabrication method of a liquid crystal display apparatus according to the present invention includes the steps of fabricating a first substrate by forming a pixel circuit on a first transparent substrate, fabricating a second substrate by forming a black matrix made of a resin and a color filter coloring transmitted light therethrough, on a second transparent substrate; and disposing the first and second substrates in parallel with each other and sealing a liquid crystal layer between the first and second substrates. The step of fabricating the first substrate includes forming a first conductive layer on the first transparent substrate, patterning the first conductive layer by using photolithography to form a gate interconnection, forming a gate insulating film, a semiconductor layer, and a second conductive layer on the first transparent substrate in this order so as to cover the gate interconnection, patterning the second conductive layer and the semiconductor layer by using photolithography to form a source interconnection, a drain interconnection and a semiconductor region, forming a contact hole in the gate insulating film by using photolithography, forming a transparent conductive layer on the gate insulating film so as to cover the source interconnection, the drain interconnection and the semiconductor region, and patterning the transparent conductive layer by using photolithography to form a pixel electrode. A sum of heights of steps created by the pixel circuit in the first substrate and by the black matrix and the color filter in the second substrate is equal to, or greater than, 0.8 μm. A pre-tilt angle of the liquid crystal layer is equal to, or greater than, 4 degrees.

In the present invention, since the first substrate is fabricated by four photolithography steps, the cost of the liquid crystal display apparatus can be reduced. Even if the sum of the step heights in the first and second substrates is equal to, or greater than, 0.8 μm, the occurrence of orientation disorder can be prevented in such a way that: the pixel circuit and the black matrix are separately formed in the different substrates so that the steps are distributed in the different substrates; and the pre-tilt angle of the liquid crystal layer is set to 4 degrees or more. The black matrix formed of a resin can also reduce the cost of the liquid crystal display apparatus.

According to the present invention, it is possible to obtain a liquid crystal display apparatus with reduced cost due to the black matrix formed of a resin while the liquid crystal display apparatus can prevent orientation disorder of the liquid crystal layer because the black matrix is provided in the second substrate and the pre-tilt angle of the liquid crystal layer is set to 4 degrees or more.

### BRIEF DESCRIPTION OF THE DRAWINGS

FIG. 1 is a cross-sectional view showing a conventional liquid crystal panel;

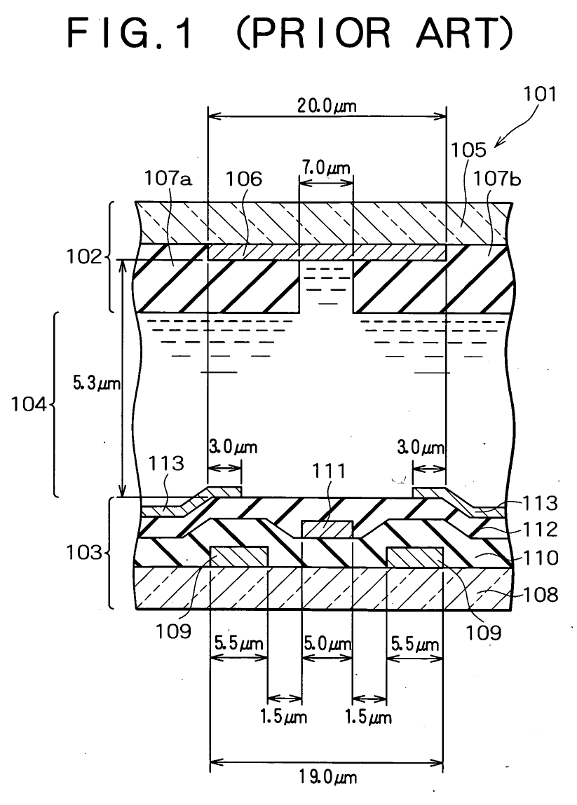

FIG. 2 is a flowchart showing a fabrication method of an array substrate of the conventional liquid crystal panel;

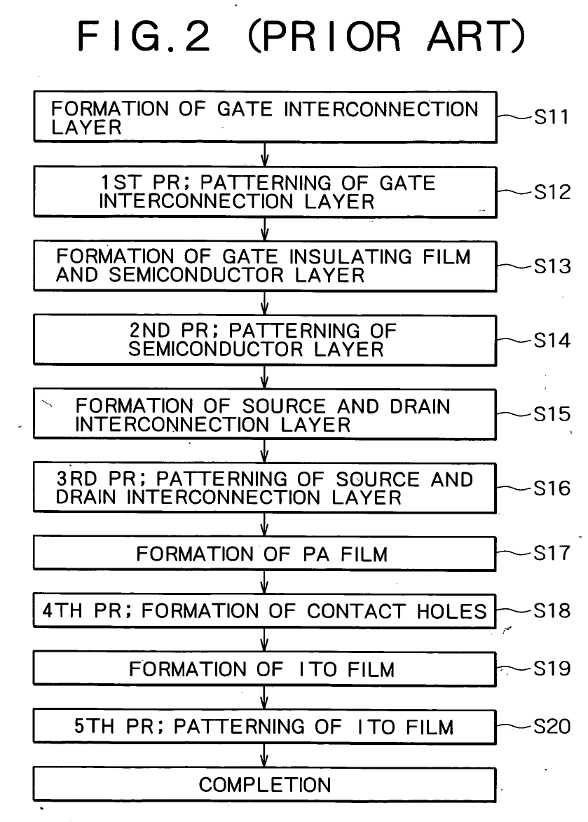

FIGS. 3A to 3D are cross-sectional views showing the fabrication method in order of the process steps;

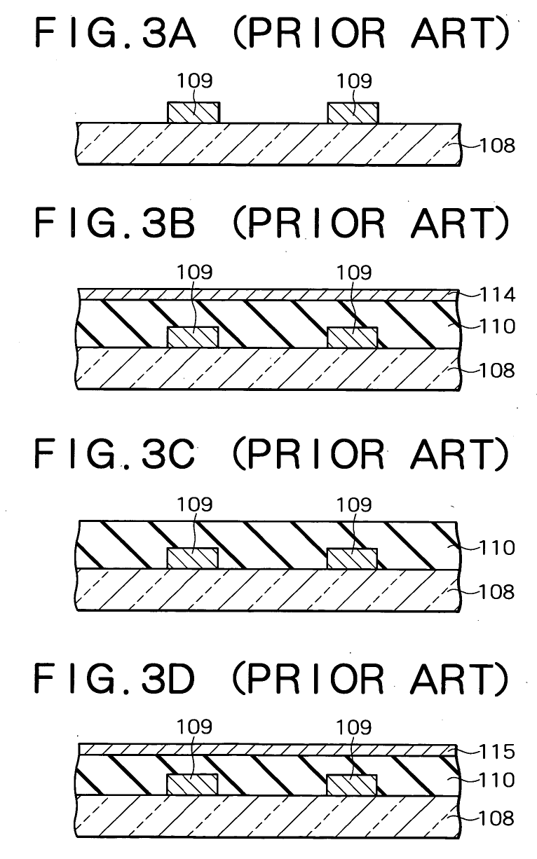

FIGS. 4A to 4D are cross-sectional views showing the fabrication method in order of the process steps following the step of FIG. 3D;

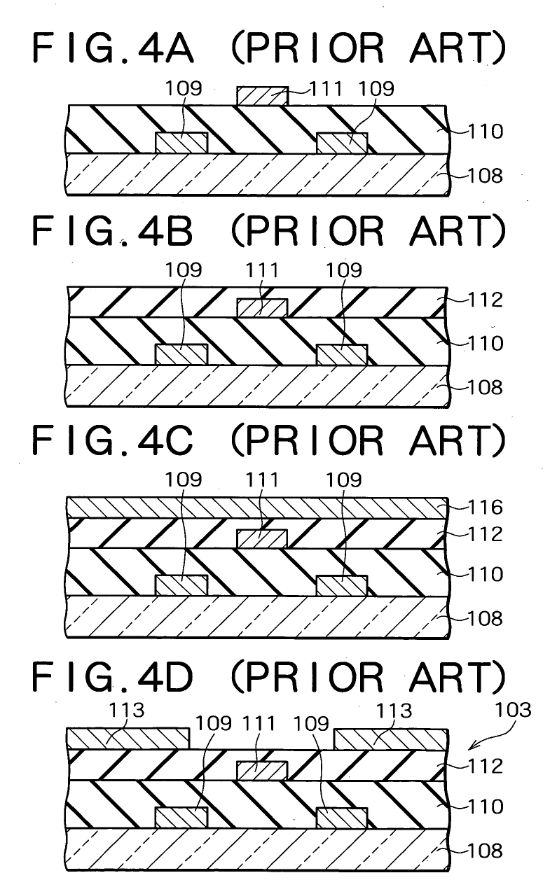

FIG. 5 is a cross-sectional view showing a liquid crystal panel of a liquid crystal display apparatus according to an embodiment of the invention;

FIG. 6 is a flowchart showing a fabrication method of an array substrate of the liquid crystal panel according to the present embodiment;

FIGS. 7A to 7C are cross-sectional views showing the fabrication method in order of the process steps; and

FIGS. 8A to 8C are cross-sectional views showing the fabrication method in order of the process steps following the step of FIG. 7C.

### DETAILED DESCRIPTION OF THE PREFERRED EMBODIMENT

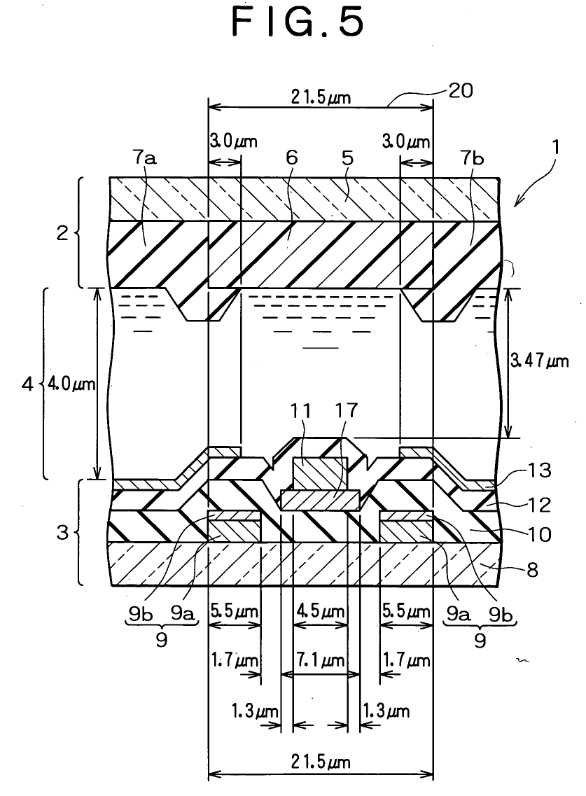

An embodiment of the present invention will now be described with reference to the accompanying drawings. FIG. 5 is a cross-sectional view showing a liquid crystal panel of a liquid crystal display apparatus according to the embodiment of the invention. The dimensions of each part of the liquid crystal panel of the present embodiment are shown in FIG. 5 as an example, but not limited to the ones shown in FIG. 5. In the liquid crystal display apparatus according to the present embodiment, a light source (not shown), a liquid crystal panel, and a frame body (not shown) housing these components are provided. Further, as shown in FIG. 5, the liquid crystal panel 1 has a color filter substrate 2 and an array substrate 3 which are provided in parallel with each other. A liquid crystal layer 4 is sealed between the color filter substrate 2 and array substrate 3.

In the color filter substrate 2, a transparent substrate 5 formed of, for example, glass is provided and a black matrix 6 formed of a resin is provided on the surface of the transparent substrate 5 facing to the array substrate 3. On the surface of the color filter substrate 2, color filters 7a and 7b are provided on both sides of the black matrix 6. The edges of the color filters 7a and 7b are formed so as to mount on the edges of the black matrix 6, so that the mounted portions of the color filters 7a and 7b are projected with respect to the other portions. The color filters 7a and 7b are, for example, red (R) and green (G) filters, respectively. A blue (B) filter (not shown) is also provided in the color filter substrate 2.

In the array substrate 3, a transparent substrate 8 formed of, for example, glass is provided and a plurality of gate interconnections 9 are provided on the surface of the transparent substrate 8 facing to the color filter substrate 2. In FIG. 5, two of the gate interconnections 9 provided in pairs are only seen. The interconnection 9 has a multi-layer structure including a lower film 9a of, for example, aluminum (Al) and an upper film 9b of, for example, molybdenum (Mo). A gate insulating film 10 of, for example, a silicon nitride (SiNx) film is also provided on the surface of the array substrate 3 so as to cover the gate interconnections 9. Steps reflecting the shapes of the gate interconnections 9 are created in part of the gate insulating film 10 corresponding to the region directly above the gate interconnections 9.

Further, a semiconductor region 17 of amorphous silicon (a-Si) is provided on part of the gate insulating film 10 directly above the region between the gate interconnections 9, and a drain interconnection 11 of, for example, chromium (Cr) is provided on the semiconductor region 17. A passivation film (PA film) 12 of, for example, a silicon nitride (SiNx) film is provided so as to cover the semiconductor region 17 and the drain interconnections 11, and pixel electrodes 13 of an ITO film are provided on the passivation film 12. The pixel electrodes 13 are provided in an area except directly above the region between the gate interconnections 9, that is, when viewed from a direction perpendicular to the surface of the transparent substrate 8 or in plan view, the edges of the pixel electrodes 13 overlap with the edges of the gate interconnections 9. The edges of the pixel electrodes 13 and the exposed area of the passivation film 12 are projected due to an effect of the shapes of the gate interconnections 9 and drain interconnection 11.

On the surface of the array substrate 3, a plurality of TFTs (not shown) are arrayed in a matrix to form a pixel circuit. The TFT has the gate interconnection 9, the drain interconnection 11, the source interconnection (not shown), and the semiconductor region 17. In plan view, the drain interconnection 11 is disposed at a position overlapping with the part of the black matrix 6 not covered with the color filters 7a and 7b. Each pixel of the liquid crystal panel 1 comprises a single color filter provided in the color filter substrate 2 and a single TFT provided in the array substrate 3.

Exemplary dimensions of each part of the liquid crystal panel 1 are as follows. In the cross-section shown in FIG. 5, the width and the thickness of the black matrix 6 are 21.5 μm and 1.5 μm, respectively. In plan view, the overlapping regions between the black matrix 6 and each of the color filters 7a and 7b are 3.0 μm respectively in length and 0.30 μm in height. This implies that the height of the steps in the color filter substrate 2 is 0.30 μm. The part of the black matrix 6 not covered with the color filters 7a and 7b, i.e., contacting directly, or via an orientation film (not shown), with the liquid crystal layer 4, is approximately 15.5 μm wide.

The gate connection 9 is 5.5 μm wide, wherein its lower film 9a of Al has a thickness of 200 nm and its upper film 9b of Mo has a thickness of 70 nm, resulting in a total thickness of 270 nm. The spacing between the gate interconnections 9 is 10.5 μm. The width and the thickness of the semiconductor region 17 are 7.1 μm and 230 nm, respectively. The width and the thickness of the drain interconnection 11 are 4.5 μm and 300 nm, respectively. In plan view, the drain interconnection 11 is positioned in the center of the semiconductor region 17. Accordingly, in plan view, the distances between each edge of the semiconductor region 17 and each edge of the drain interconnection 11 are 1.3 μm respectively on both sides. In plan view, the spacing between the semiconductor region 17 and the gate interconnection 9 is 1.7 μm. Therefore, in plan view, a region 20 including the two gate interconnections 9 and the region therebetween is 21.5 μm wide, and matches the region where the black matrix 6 is provided in the color filter substrate 2. The thicknesses of the gate insulating film 10, the passivation film 12, and the pixel electrode 13 are 300 nm, 150 nm, and 40 nm, respectively.

Further, the distance between part of the surface of the color filter 7a not overlapping with the black matrix 6 and part of the surface of the pixel electrode 13 not overlapping with the gate interconnection 9 is designed to be 4.0 μm. In this case, the distance between the most projecting portion of the passivation film 12, i.e., the part of the surface directly above the drain interconnection 11, and the surface of the black matrix 6 is 3.47 μm. This implies that the height of the steps in the array substrate 3 is 0.53 μm. Therefore, in part of the liquid crystal panel 1 shown in FIG. 5, the sum of the step heights in the color filter substrate 2 and array substrate 3 is 0.83 μm.

Further, the liquid crystal layer 4 is formed of a twisted nematic (TN) type of liquid crystal having a pre-tilt angle of 4 degrees or more, for example, 4 to 10 degrees, for example, 4.5 to 5.5 degrees.

Next, the reason for restricting the numerical values in the present invention will be described. According to the present invention, when the sum of the step heights in the color filter substrate 2 and the array substrate 3 is greater than or equal to 0.8 μm, the pre-tilt angle of the liquid crystal layer must be 4 degrees or more. This is because, if the pre-tilt angle is less than 4 degrees, the orientation of the liquid crystal molecules cannot be aligned normally along the vertical steps so that orientation disorder such as the reverse tilt and the like will occur. The orientation disorder causes the discrination to occur at these locations, resulting in the occurrence of display defects such as the bright lines and the like in an image.

When the sum of the step heights in the color filter substrate 2 and the array substrate 3 is greater than or equal to 1.2 μm, the pre-tilt angle should preferably be 5 degrees or more. Further, the pre-tilt angle of the liquid crystal layer should preferably be 10 degrees or less. One reason for this is that it is extremely difficult to form a liquid crystal layer having a pre-tilt angle of greater than 10 degrees. Another reason is that, if the pre-tilt angle exceeds 10 degrees, the molecules of the liquid crystal often happen to orientate to undesirable directions, resulting in unstable orientation.

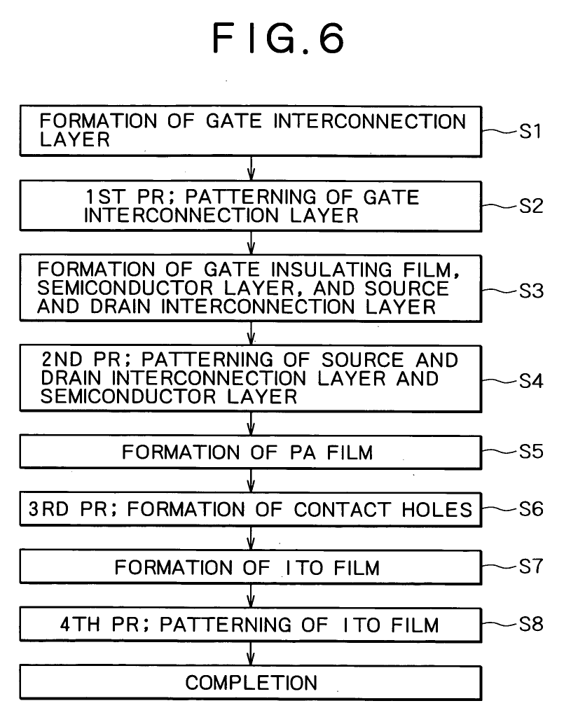

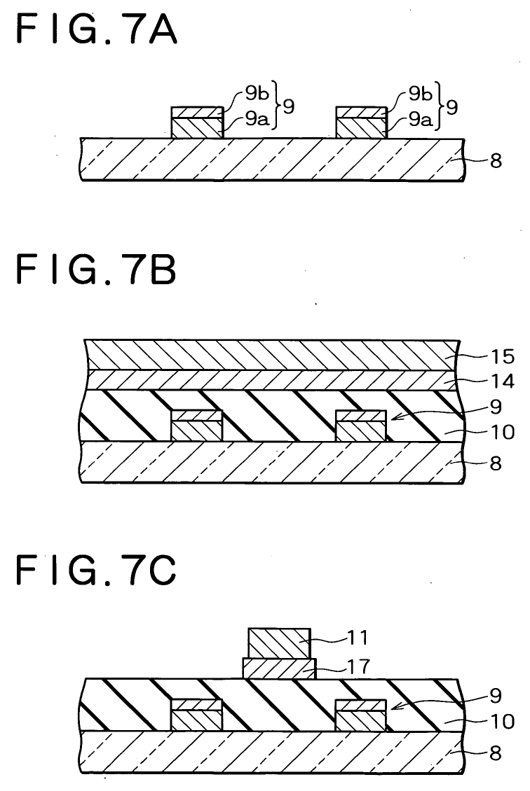

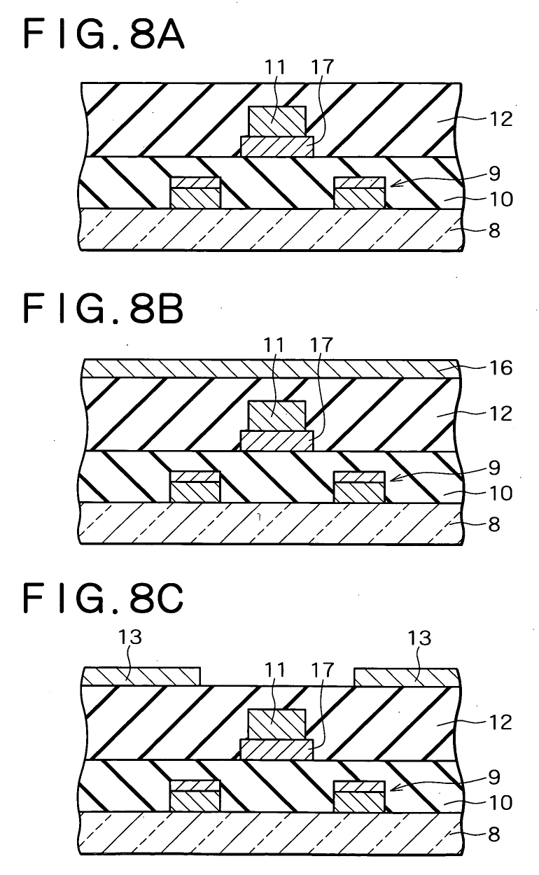

Next, a fabrication method of the above-described liquid crystal panel of the present embodiment will be described. FIG. 6 is a flowchart showing the fabrication method of the array substrate of the liquid crystal panel. FIGS. 7A to 7C and FIGS. 8A to 8C are cross-sectional views showing the fabrication method in order of the process steps. In the present embodiment, the array substrate 3 of the liquid crystal panel 1 is fabricated by the 4PR method in which photolithography (PR) is performed four times.

First, in step S1 in FIG. 6, an Al film having a thickness of, for example, 200 nm is formed on the transparent substrate 8, and then a Mo film having a thickness of, for example, 70 nm is formed. Next, as shown in step S2 and in FIG. 7A, the first photolithograph (PR) is performed and the Al and Mo films are patterned to form the gate interconnections 9. In this case, the gate interconnection 9 is formed as a double-layer film having the upper layer film 9b of Mo stacked on the lower layer film 9a of Al. Next, as shown in step S3 and in FIG. 7B, the gate insulating film 10 of silicon nitride having a thickness of, for example, 300 nm is formed on the transparent substrate 8 so as to cover the gate interconnections 9. Subsequently, the semiconductor layer 14 of amorphous silicon (a-Si) is formed with a thickness of, for example, 230 nm and then a source and drain interconnection layer 15 of Cr is formed with a thickness of, for example, 300 nm.

Next, as shown in step S4 and in FIG. 7C, the second PR is performed and the source and drain interconnection layer 15 and the semiconductor layer 14 are patterned to form the drain interconnection 11, the source interconnection (not shown), and the semiconductor region 17. This second PR process will be described in detail below.

First, a photoresist film (not shown) is formed on the source and drain interconnection layer 15. Next, the photoresist film is exposed by using a gray-tone mask, and is developed to form a resist pattern. Two-layer resist patterns are thereby formed, in which thick part is formed in the regions where the drain interconnection 11 and the source interconnection will be formed and thin part is formed in the region where the drain interconnection 11 and the source interconnection will not be formed but only the semiconductor region 17 is formed. By using this resist pattern as a mask, the source and drain interconnection layer 15 and the semiconductor layer 14 are etched and selectively removed to form the semiconductor region 17. Next, ashing is performed to partially remove the resist pattern, so that the thin-formed part of the resist pattern is removed and only the thick-formed part of the resist pattern remains. The source and drain interconnection layer 15 is then etched and selectively removed by using the post-ashing resist pattern as a mask to form the drain interconnection 11 and the source interconnection.

Next, as shown in step S5 and in FIG. 8A, the passivation film 12 of silicon nitride having a thickness of, for example, 150 nm is formed on the gate insulating film 10 so as to cover the drain interconnection 11 and the source interconnection. Next, in step S6, the third PR is performed, and the passivation film 12 and the gate insulating film 10 are selectively removed to form contact holes (not shown).

Next, as shown in step S7 and in FIG. 8B, the ITO film 16 is formed on the passivation film 12 with a thickness of, for example, 40 nm. Next, as shown in step S8 and in FIG. 8C, the fourth PR is performed and the ITO film 16 is patterned to form the pixel electrodes 13.

Subsequently, an orientation film (not shown) is formed on the passivation film 12 and the pixel electrodes 13, and then rubbing is performed on the surface of the orientation film. This rubbing is performed under the condition that the liquid crystal layer 4 (see FIG. 5), which will be formed in the later process, can have a pre-tilt angle of 4 degrees or more. The array substrate 3 is thus formed.

In the color filter substrate 2, as shown in FIG. 5, the black matrix 6 of a resin is formed on the glass substrate 5, and then the color filters 7a and 7b are formed so as to cover the edges of the black matrix 6. The color filter substrate 2 is thus formed. After that, the array substrate 3 and the color filter substrate 2 are combined in parallel with each other by using seal (not shown), and then liquid crystal is sealed into the space enclosed by the color filter substrate 2, the array substrate 3, and the seal to form the liquid crystal layer 4. In this case, the pre-tilt angle of the liquid crystal layer 4 becomes 4 degrees or more, for example, 4 to 10 degrees, and preferably for example, 4.5 to 5.5 degrees. The liquid crystal panel 1 is thus fabricated. The liquid crystal display apparatus according to the present embodiment is then fabricated by housing this liquid crystal panel 1 and a light source into a frame body.

In the present embodiment, since the black matrix is provided in the color filter substrate, the leakage current caused by the black matrix does not occur in the pixel circuit, thereby obtaining the pixel circuit having an excellent performance. Further, the black matrix formed of a resin leads to low cost, and not using Cr can reduce an environmental load as well. The color filter substrate without an overcoat layer also leads to low cost. Furthermore, since the array substrate is fabricated using the four photolithography (PR) steps, fabrication cost can be reduced.

In the present embodiment, as described above, the black matrix is formed of a resin, an overcoat layer is not used, and the array substrate is formed by using the 4 PR method. Therefore, the step heights in the color filter substrate and the array substrate become larger in comparison with conventional liquid crystal panels, and sum up to 0.8 μm or more. In the present embodiment, however, since the pixel circuit and the black matrix 6 are separately formed in the different substrates, i.e., the color filter substrate 2 and the array substrate 3, so that the steps are distributed in the different substrates, and the pre-tilt angle of the liquid crystal layer is set to 4 degrees or more, orientation disorder such as the reverse tilt and the like will not occur in the liquid crystal layer. Accordingly, display defects caused by the orientation disorder do not occur, leading to a good display quality.

Effects of examples according to the present invention will be specifically described below in comparison with comparative examples outside the scope of the invention. A plural number of the liquid crystal display apparatus as shown in FIG. 5 were fabricated by using the fabrication method of the liquid crystal display apparatus according to the embodiment of the invention described above, i.e., the method shown in FIGS. 6A to 6C and FIGS. 7A to 7C. At that time, the sum of the step heights in the color filter substrate and the array substrate and the pre-tilt angle of the liquid crystal are each varied among the liquid crystal display apparatus. The pre-tilt angles were controlled by adjusting the rubbing conditions. The sum of the step heights was varied from 0.2 to 0.8 μm, and the pre-tilt angle was varied from 2 to 6 degrees. Then, an image was displayed on these liquid crystal display apparatus to check whether the discrination occurred or not. Further, computer simulations were carried out to check whether the discrination occurred or not in liquid crystal display apparatus having sums of the step heights of from 1.0 to 1.2 μm and pre-tilt angles of from 0 to 6 degrees.

These results are shown in table 1. In table 1, ‘sum of the step heights’ indicates the total value of the step heights in the color filter substrate and the array substrate. The symbols in table 1 indicate as follows: ‘◯’ indicates that the discrination did not occur; ‘Δ’ indicates that the discrination slightly occurred, but at a level causing no problem in practical use; ‘X’ indicates that the discrination occurred; and ‘-’ indicates that the evaluation was not performed. In table 1, the results shown with the parenthesis were obtained from the simulations and the ones shown without the parenthesis from the evaluations of the actual panels.

TABLE 1

| | | SUM OF THE STEP HEIGHT (μm) | | | | | |
|---|---|---|---|---|---|---|---|
| | | 0.2 | 0.4 | 0.6 | 0.8 | 1.0 | 1.2 |
| PRE-TILT ANGLE | 6 | — | — | — | ◯ | (◯) | (◯) |
| (°) | 5 | — | — | — | ◯ | (◯) | (◯) |
| | 4 | — | — | — | ◯ | (◯) | (Δ) |
| | 3 | ◯ | ◯ | ◯ | X | (X) | (X) |
| | 2 | ◯ | X | X | X | (X) | (X) |
| | 1 | — | — | — | — | (X) | (X) |
| | 0 | — | — | — | — | (X) | (X) |

As shown in table 1, even if the sum of the step heights was 0.8 μm or more, when the pre-tilt angle was set to 4 degrees or more, the discrination did not occur so that a good display quality was obtained. If the sum of the step heights was 1.2 μm or more, much better display could be obtained by setting the pre-tile angle to 5 degrees or more.

1. A liquid crystal display apparatus comprising:
a first substrate, said first substrate comprising:
a first transparent substrate; and
a pixel circuit which is provided on the surface of said first transparent substrate;
a second substrate provided in parallel with said first substrate, said second substrate comprising:
a second transparent substrate;
a black matrix made of a resin provided on said second transparent substrate; and
a color filter which is provided on said second transparent substrate and colors transmitted light therethrough; and
a liquid crystal layer sealed between said first and second substrates, and applied a voltage by said pixel circuit, a sum of heights of steps created on the surfaces of said first and second substrates both facing said liquid crystal layer being equal to, or greater than, 0.8 μm, and a pre-tilt angle of said liquid crystal layer being equal to, or greater than, 4 degrees.

2. The liquid crystal display apparatus according to claim 1, wherein said sum of the heights of the steps is equal to, or greater than, 1.2 μm, and said pre-tilt angle of said liquid crystal layer is equal to, or greater than, 5 degrees.

3. The liquid crystal display apparatus according to claim 1, wherein said pre-tilt angle of said liquid crystal layer is equal to, or smaller than, 10 degrees.

4. A fabrication method of a liquid crystal display apparatus comprising the steps of:
fabricating a first substrate by forming a pixel circuit on a first transparent substrate, the step of fabricating said first substrate comprising:
forming a first conductive layer on said first transparent substrate;
patterning said first conductive layer by using photolithography to form a gate interconnection;
forming a gate insulating film, a semiconductor layer, and a second conductive layer on said first transparent substrate in this order so as to cover said gate interconnection;
patterning said second conductive layer and said semiconductor layer by using photolithography to form a source interconnection, a drain interconnection and a semiconductor region;
forming a contact hole in said gate insulating film by using photolithography;
forming a transparent conductive layer on said gate insulating film so as to cover said source interconnection, said drain interconnection and said semiconductor region; and
patterning said transparent conductive layer by using photolithography to form a pixel electrode;
fabricating a second substrate by forming a black matrix made of a resin and a color filter coloring transmitted light therethrough, on a second transparent substrate; and
disposing said first and second substrates in parallel with each other and sealing a liquid crystal layer between said first and second substrates, a sum of heights of steps created by said pixel circuit in said first substrate and by said black matrix and said color filter in said second substrate being equal to, or greater than, 0.8 μm, and a pre-tilt angle of said liquid crystal layer being equal to, or greater than, 4 degrees.

5. The fabrication method of a liquid crystal display apparatus according to claim 4, wherein said sum of the heights of the steps is equal to, or greater than, 1.2 μm, and the pre-tilt angle of said liquid crystal layer is equal to, or greater than, 5 degrees.

6. The fabrication method of a liquid crystal display apparatus according to claim 4, wherein said pre-tilt angle of said liquid crystal layer is equal to, or smaller than, 10 degrees.

7. The fabrication method of a liquid crystal display apparatus according to claim 4, wherein the step of patterning said second conductive layer and said semiconductor layer comprises the steps of:
forming a photoresist film on said second conductive layer;
exposing said photoresist film using a gray-tone mask and developing to form a resist pattern being relatively thick in a region where said source interconnection and said drain interconnection are to be formed and relatively thin in a region where said source interconnection and said drain interconnection are not to be formed but said semiconductor region is to be formed;
etching by using said resist pattern as a mask to selectively remove said second conductive layer and said semiconductor layer so as to form said semiconductor region;
ashing said resist pattern to remove the relatively thin portion of said resist pattern and remain the relatively thick portion of said resist pattern; and
etching by using said resist pattern after ashing as a mask to selectively remove said second conductive layer so as to form said source interconnection and said drain interconnection.
